(19) United States
(12) Patent Application Publication
(10) Pub. No.: US 2026/0254899 A1
(43) Pub. Date: Aug. 27, 2026

(54) IMAGE FORMING APPARATUS THAT COLLECTS STATUS OF CONVEYING BELT

(71) Applicant: KYOCERA Document Solutions Inc., Osaka (JP)

(72) Inventor: Masayuki MIYAKE, Osaka (JP)

(73) Assignee: KYOCERA Document Solutions Inc., Osaka (JP)

(21) Appl. No.: 19/538,127

(22) Filed: Feb. 12, 2026

(30) Foreign Application Priority Data
Feb. 21, 2025 (JP) 2025-027323

(51) Int. Cl. H04N 1/00; B41J 11/00

(52) U.S. Cl. CPC H04N 1/00015; H04N 1/00029; H04N 1/00045; H04N 1/00063; H04N 1/00068; H04N 1/00076; H04N 1/0009; H04N 1/00602; B41J 11/007

(57) ABSTRACT

An image forming apparatus includes a conveying belt, an image pickup device, a storage device, and a control device. The control device includes a processor, and acts as a controller when the processor executes a program. The conveying belt transports a recording sheet, by performing a revolving movement. The image pickup device shoots an image of the conveying belt. The controller calculates a belt status value on a basis of the image of the conveying belt shot by the image pickup device, at a predetermined first time interval, and stores the calculated belt status value in the storage device.

### INCORPORATION BY REFERENCE

This application claims priority to Japanese Patent Application No.2025-027323 filed on Feb. 21, 2025, the entire contents of which are incorporated by reference herein.

### BACKGROUND

The present disclosure relates to an image forming apparatus provided with a conveying belt.

Many of existing image forming apparatuses are configured to store, when an error occurs therein, the information about the error that has occurred, in an external memory, and find a remedy for the error, by analyzing the error information stored in the external memory.

### SUMMARY

The disclosure proposes further improvement of the foregoing technique.

In an aspect, the disclosure provides an image forming apparatus including a conveying belt, an image pickup device, a storage device, and a control device. The control device includes a processor, and acts as a controller when the processor executes a program. The conveying belt transports a recording sheet, by performing a revolving movement. The image pickup device shoots an image of the conveying belt. The controller calculates a belt status value on a basis of the image of the conveying belt shot by the image pickup device, at a predetermined first time interval, and stores the calculated belt status value in the storage device.

### BRIEF DESCRIPTION OF THE DRAWINGS

FIG. 1 is a cross-sectional view showing an outline of an image forming apparatus according to an embodiment of the disclosure;

FIG. 2 is a functional block diagram showing an electrical configuration of the image forming apparatus shown in FIG. 1;

FIG. 3 is a schematic plan view showing the conveying belt shown in FIG. 1;

FIG. 4A is a schematic diagram showing location of the conveying belt and the CIS unit shown in FIG. 1;

FIG. 4B is a schematic diagram showing another location of the conveying belt and the CIS unit shown in FIG. 1;

FIG. 5 is a schematic diagram showing flow of data in a data collection process and a data analysis process, performed in the image forming apparatus shown in FIG. 2;

FIG. 6 is a flowchart for explaining the data collection process performed by the image forming apparatus shown in FIG. 2; and

FIG. 7 is a flowchart for explaining the data analysis process, performed by the image forming apparatus shown in FIG. 2.

### DETAILED DESCRIPTION

Hereafter, an image forming apparatus 1 according to an embodiment of the disclosure will be described, with reference to the drawings.

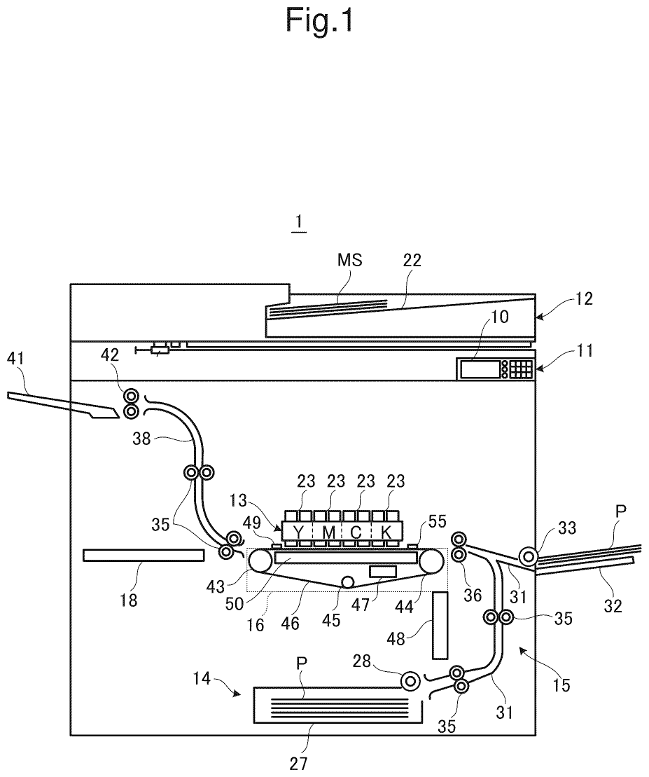

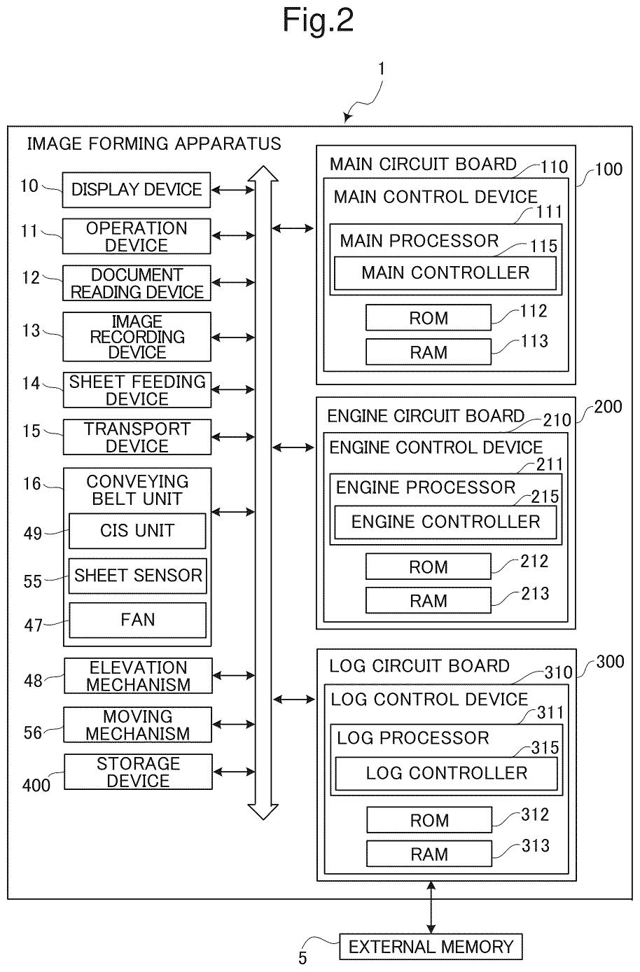

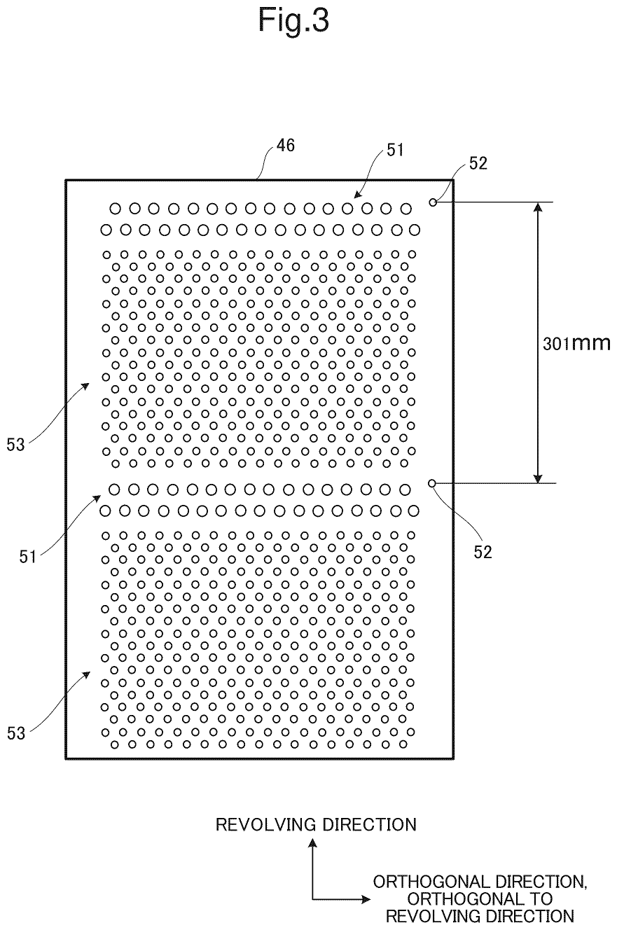

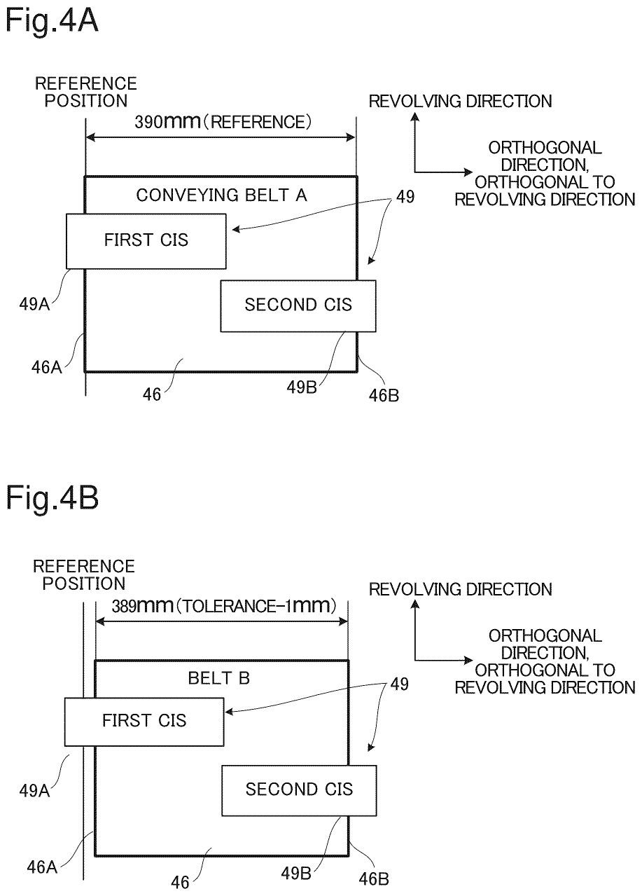

Referring first to FIG. 1 to FIG. 4B, a configuration of the image forming apparatus 1, according to the embodiment of the disclosure, will be described. FIG. 1 is a cross-sectional view showing an outline of the image forming apparatus 1 according to the embodiment of the disclosure. FIG. 2 is a functional block diagram showing an electrical configuration of the image forming apparatus 1 shown in FIG. 1. FIG. 3 is a schematic plan view showing the conveying belt 46 shown in FIG. 1. FIG. 4A and FIG. 4B are schematic diagrams each showing the location of the conveying belt 46 and the CIS unit 49 shown in FIG. 1. The image forming apparatus 1 is an inkjet recording apparatus. Instead, the image forming apparatus 1 may be an apparatus other than the inkjet recording apparatus.

The image forming apparatus 1 includes a display device 10, an operation device 11, a document reading device 12, an image recording device 13, a sheet feeding device 14, a transport device 15, a conveying belt unit 16, and a cap 18.

The display device 10 and the operation device 11 are located on the front side of the image forming apparatus 1, at a position close to the document reading device 12. The display device 10 includes a display panel, and displays, under the control of a main controller 115, graphical user interface (GUI) screens, on which the user performs various operations related to the functions of the image forming apparatus 1, such as a home screen, a log-in screen, a copying screen, a transmission screen, and a job history screen. The operation device 11 includes a touch panel and a keyboard, overlaid on the display panel of the display device 10, and receives instructions inputted by the user, related to the functions that the image forming apparatus 1 is configured to perform.

When a document MS is placed on a document tray 22, the document reading device 12 draws out the document MS from the document tray 22, and reads the image of the document MS with an image sensor, while the document MS is being transported. The analog output of the image sensor is converted to a digital signal, and image data representing the image of the document MS is generated.

The image recording device 13 prints the image of the document MS, represented by the image data, on a recording sheet P being transported by the conveying belt 46 of the conveying belt unit 16, by ejecting ink droplets of four colors, namely black, cyan, magenta, and yellow onto the recording sheet P, thereby forming a color image on the recording sheet P. To be more specific, the image recording device 13 includes line heads 23, respectively corresponding to the black, cyan, magenta, and yellow colors. Therefore, the image forming apparatus 1 is a line-head type inkjet recording apparatus. The line head is an example of an ink head.

The recording sheet P is picked up from the sheet feeding device 14, and transported to the conveying belt 46 of the conveying belt unit 16 along a transport route 31 of the transport device 15. The recording sheet P is further transported from the conveying belt 46 along a transport route 38 of the transport device 15, and delivered to an output tray 41.

The sheet feeding device 14 includes a sheet cassette 27. The sheet cassette 27 includes a sheet feeding roller 28, which picks up the recording sheet P stored in the sheet cassette 27, and delivers the recording sheet P to the transport route 31.

The sheet feeding device 14 also includes a manual bypass tray 32, provided on a wall face of the main body of the image forming apparatus 1. The recording sheet P set on the manual bypass tray 32 is picked up by a sheet feeding roller 33, and delivered to the transport route 31.

The transport device 15 includes the transport route 31 along which the recording sheet P delivered from the sheet feeding device 14 is transported, transport rollers 35 provided at predetermined positions along the transport routes 31 and 38, a resist roller 36 that delivers the recording sheet P to the conveying belt 46 of the conveying belt unit 16, after correcting the skew of the recording sheet P, the transport route 38 along which the recording sheet P delivered from the conveying belt 46 is transported, and a delivery roller 42 that delivers the recording sheet P transported along the transport route 38, to the output tray 41.

The conveying belt unit 16 includes a drive roller 43, a follower roller 44, a tension roller 45, the conveying belt 46, a fan 47, a contact image sensor (CIS) unit 49, a sheet sensor 55, and a worktable 50.

The conveying belt 46 is an endless belt stretched around the drive roller 43, the follower roller 44, and the tension roller 45, and having the face on the opposite side of the image recording device 13 opposed to the upper face of the worktable 50. The drive roller 43 is driven to rotate counterclockwise by a non-illustrated motor, and when the drive roller 43 is made to rotate, the conveying belt 46 is made to revolve counterclockwise, and the follower roller 44 and the tension roller 45 are also made to rotate counterclockwise, following up the movement of the conveying belt 46. The conveying belt 46 conveys the recording sheet P, by revolving with the recording sheet P, received from the transport route 31 of the transport device 15, placed thereon.

The conveying belt 46 is an endless belt as mentioned above and, in this embodiment, has a reference width of, for example, 390 mm as shown in FIG. 4A, in an orthogonal direction orthogonal to the revolving direction of the conveying belt 46 (transport direction in which the conveying belt 46 transports the recording sheet P). For example, the drive roller 43 and the follower roller 44 each include a column-shaped component that rotates interlocked with the rotation shaft of the corresponding roller, and extends along the rotation shaft (same direction as the orthogonal direction), and the conveying belt 46 is stretched around such column-shaped components. Here, a position on the circumferential surface of the respective column-shaped components of the drive roller 43 and the follower roller 44, at a predetermined distance (e.g., 10 mm) from an end portion in the direction of the rotation shaft of the column-shaped component, will be defined as a reference position. The conveying belt 46 is mounted on the column-shaped component, with an end portion 46A thereof in the direction of the rotation shaft, positioned at the reference position.

However, the conveying belt 46 is not free from a dimension tolerance and mounting error, and therefore, when the conveying belt 46 is mounted on the column-shaped component, the end portion 46A of the conveying belt 46 may be deviated from the reference position, as shown in FIG. 4B. FIG. 4B is a schematic drawing showing the state where the tolerance of the conveying belt 46 is −1 mm, and therefore the width of the conveying belt 46 in the orthogonal direction 389 mm.

In addition, as shown in FIG. 3, the conveying belt 46 includes ink spitting holes 51 through which the image recording device 13 spits dry ink, during head cleaning (an example of maintenance work of the image forming apparatus 1), home position holes 52 located close to the ink spitting hole 51, for acquiring the position of the conveying belt 46 along the revolving direction, and suction holes 53 for adsorbing the recording sheet P. In this embodiment, the conveying belt 46 includes eleven home position holes 52, each located at a predetermined position along the orthogonal direction orthogonal to the revolving direction of the conveying belt 46, and aligned in the revolving direction at regular intervals (e.g., 301 mm). For example, the interval between the home position holes 52 adjacent to each other, among the eleven home position holes 52, may differ from the above, owing to the tolerance of the conveying belt 46. Accordingly, the revolution speed of the conveying belt 46, calculated on the basis of the home position holes 52, may vary from each other among a plurality of image forming apparatuses 1.

The tension roller 45 serves to maintain the tension of the conveying belt 46 at an appropriate level.

The worktable 50 accommodates therein the fan 47, and serves as a base when the image recording device 13 records an image on the recording sheet P on the conveying belt 46. The worktable 50 includes holes formed in a region opposed to the respective line heads 23 of the black, cyan, magenta, and yellow colors across the conveying belt 46, so as to correspond to the respective ink spitting holes 51 of the conveying belt 46, and also holes corresponding to the respective suction holes 53 of the conveying belt 46.

The sheet sensor 55 is located on the transport route 31 at a position upstream of the image recording device 13, to detect the presence of the recording sheet P on the conveying belt 46 being transported toward the image recording device 13, and output the detection result to an engine control device 210 of an engine circuit board 200. The sheet sensor 55 is, for example, an optical sensor having a light emitter and a photodetector, located so as to oppose the surface of the conveying belt 46. When the light emitter emits light onto the surface of the conveying belt 46 or the recording sheet placed thereon, the photodetector receives the light reflected by the surface of the conveying belt 46 or the recording sheet. The photodetector outputs the amount of the received light to the engine control device 210, as the detection result.

The fan 47 is located on the lower side of the conveying belt 46, on the upper face of which the recording sheet P is transported. In other words, the recording sheet P, the conveying belt 46, and the fan 47 are arranged in this order in the vertical direction. The fan 47 serves to adsorb the recording sheet P to the conveying belt 46 by negative pressure, by sucking air through the suction holes 53 of the conveying belt 46, and the holes of the worktable 50 respectively corresponding to the suction holes 53 of the conveying belt 46.

The CIS unit 49 includes a first CIS 49A and a second CIS 49B as shown in FIG. 4A and FIG. 4B, each of which shoots the image of the conveying belt 46. The CIS unit 49 exemplifies the image pickup device according to the disclosure.

The first CIS 49A is located on the side of one end portion 46A of the conveying belt 46, in the orthogonal direction orthogonal to the revolving direction thereof, so as to detect the region including the position of the end portion 46A of the conveying belt 46 in the orthogonal direction, and extending to the central portion of the surface of the conveying belt 46, in the orthogonal direction. The first CIS 49A shoots the image of the region of the conveying belt 46, from the end portion 46A to the central portion in the orthogonal direction, and outputs the image data of the shot image to the engine control device 210 of the engine circuit board 200.

The second CIS 49B is located on the side of the other end portion 46B of the conveying belt 46, in the orthogonal direction orthogonal to the revolving direction thereof, so as to detect the region including the position of the other end portion 46B of the conveying belt 46 in the orthogonal direction, and also the home position hole 52, and extending to the central portion of the surface of the conveying belt 46, in the orthogonal direction. The second CIS 49B shoots the image of the region of the conveying belt 46, from the other end portion 46B to the central portion in the orthogonal direction, and outputs the image data of the shot image to the engine control device 210 of the engine circuit board 200.

The elevation mechanism 48 supports the conveying belt unit 16 from below, and moves the conveying belt unit 16 up and downward with respect to the line heads 23 of the image recording device 13. In other words, the elevation mechanism 48 moves the conveying belt unit 16 relative to the line heads 23, thereby moving the conveying belt unit 16 toward and away from the line heads 23. To be more specific, the elevation mechanism 48 moves the conveying belt unit 16 between a recording position where the image recording device 13 can perform the printing operation (position shown in FIG. 1), and a maintenance position spaced downward from the recording position, by a predetermined distance.

When the conveying belt unit 16 is moved down by the elevation mechanism 48 to the maintenance position, a vacant space is defined under the image recording device 13. In such a state, the cap 18 is horizontally moved by a moving mechanism 56 (see FIG. 2) to the position right under the image recording device 13, and then moved upward by the moving mechanism 56, so as to cover the nozzles of the line heads 23 of the image recording device 13. Accordingly, the ink in the nozzles of the line heads 23 of the image recording device 13 can be prevented from drying.

The image forming apparatus 1 further includes a main circuit board 100 having a main control device 110 mounted thereon, an engine circuit board 200 having the engine control device 210 mounted thereon, a log circuit board 300 having a log control device 310 mounted thereon, and a storage device 400.

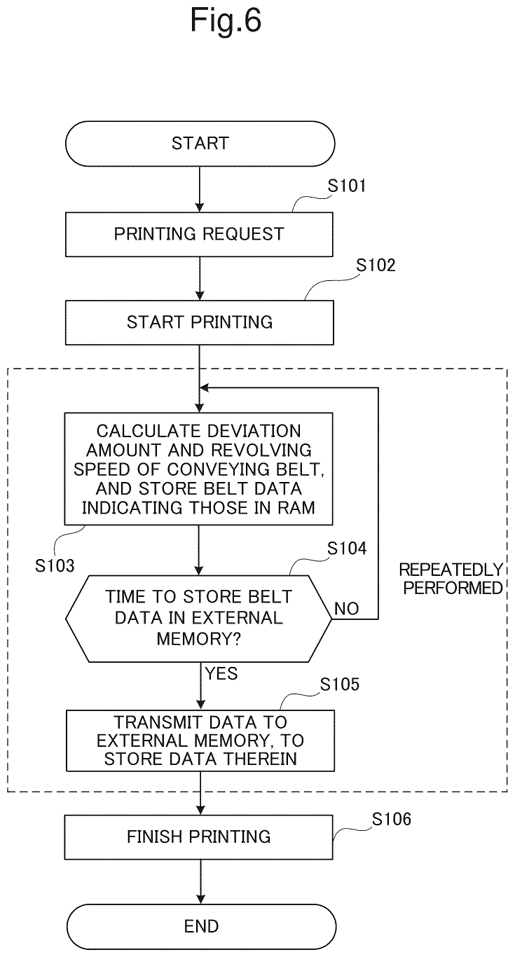

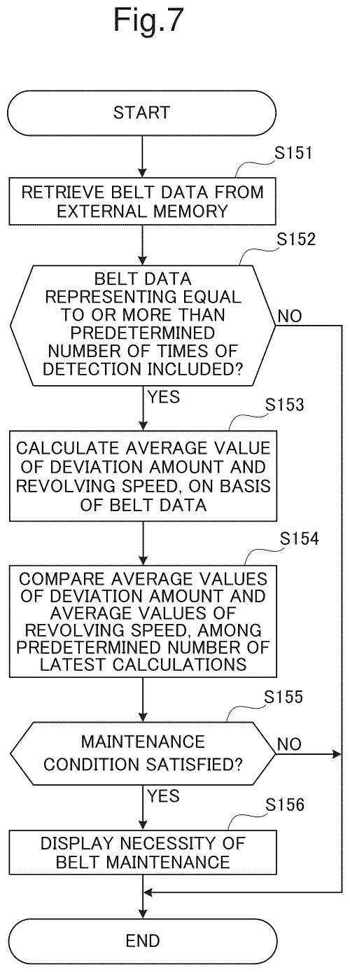

The storage device 400 is a large-capacity storage medium such as a hard disk drive (HDD) or a solid-state drive (SSD), for storing various types of data, and various computer programs including control programs for realizing the functions of the image forming apparatus 1. The storage device 400 contains a data collection program, according to which a processor of the image forming apparatus 1 (main processor 111, engine processor 211, and log processor 311) acts as a controller (main controller 115, engine controller 215, and log controller 315) that executes a data collection process, specified in FIG. 6. Likewise, the storage device 400 contains a data analysis program, according to which the processor of the image forming apparatus 1 (main processor 111, engine processor 211, and log processor 311) acts as the controller (main controller 115, engine controller 215, and log controller 315) that executes a data analysis process, specified in FIG. 7.

The main control device 110 includes a main processor 111, a read-only memory (ROM) 112 for storing various types of data and computer programs such as control programs, for realizing the functions of the image forming apparatus 1, and a random-access memory (RAM) 113 in which the main processor 111 temporarily stores the data. The main processor 111 is, for example, a central processing unit (CPU), a micro processing unit (MPU), or an application-specific integrated circuit (ASIC).

The main processor 111 acts as the main controller 115, by operating according to the computer programs stored in the storage device 400 and the ROM 112. The main controller 115 controls the operation of the display device 10, the operation device 11, the document reading device 12, the elevation mechanism 48, and the moving mechanism 56. Here, the main controller 115 may be constituted in the form of a hardware circuit, instead of being realized by the operation of the main processor 111 according to the computer programs.

The engine control device 210 includes an engine processor 211, a ROM 212 for storing various types of data and computer programs such as control programs, for realizing the functions of the image forming apparatus 1, and a RAM 213 in which the engine processor 211 temporarily stores the data. The engine processor 211 is, for example, a CPU, an MPU, or an ASIC.

The engine processor 211 acts as the engine controller 215, by operating according to the computer programs stored in the storage device 400 and the ROM 212. The engine controller 215 controls the operation of the image recording device 13, the sheet feeding device 14, the transport device 15, and the conveying belt unit 16. Here, the engine controller 215 may be constituted in the form of a hardware circuit, instead of being realized by the operation of the engine processor 211 according to the computer programs.

The log control device 310 includes a log processor 311, a ROM 312 for storing various types of data and computer programs such as control programs, for realizing the functions of the image forming apparatus 1, and a RAM 313 in which the log processor 311 temporarily stores the data. The log processor 311 is, for example, a CPU, an MPU, or an ASIC.

The log processor 311 acts as the log controller 315, by operating according to the computer programs stored in the storage device 400 and the ROM 312. The log controller 315 performs data communication, for example with an external memory 5. Here, the log controller 315 may be constituted in the form of a hardware circuit, instead of being realized by the operation of the log processor 311 according to the computer programs.

The log circuit board 300 can be connected to the external memory 5. The external memory 5 is, for example, a USB memory. When the external memory 5 is the USB memory, a USB interface, to which the USB memory is connected, is attached to the main body of the image forming apparatus 1, and the USB interface is electrically connected to the log circuit board 300. When the power to the image forming apparatus 1 is turned on, the external memory 5 is connected to the USB interface. The log controller 315 writes and retrieves various types of data, such as the belt data to be subsequently described, in and from the external memory 5 connected as above.

For example, the main controller 115 controls the motor for driving the transport roller 35 and the image sensor in the document reading device 12, to cause the document reading device 12 to transport the document MS and read the image thereof, and store the image data representing the image of the document MS, in the storage device 400.

The engine controller 215 controls the motor for driving the sheet feeding roller 33, the transport roller 35, and the resist roller 36 in the sheet feeding device 14 and the transport device 15, the motor for rotating the drive roller 43 of the conveying belt 46 in the conveying belt unit 16, and the motor for rotating the fan 47 to cause the sheet feeding device 14 to deliver the recording sheet P, and cause the conveying belt 46 to convey the recording sheet P.

The engine controller 215 detects whether the recording sheet P is present on the conveying belt 46, on the basis of the output from the sheet sensor 55, immediately before the start of the ink ejection from the line heads 23. When it is decided that the recording sheet P is present, the engine controller 215 causes the line heads 23 to start to eject the ink at a prespecified timing, and controls the line heads 23 of the image recording device 13 on the basis of the image data representing the image of the document MS, stored in the storage device 400, thereby causing the line heads 23 to eject the corresponding ink, to form the image of the document MS, on the recording sheet P on the conveying belt 46.

In addition, the engine controller 215 controls the motor and actuator of the elevation mechanism 48 and the moving mechanism 56, to move the conveying belt unit 16 up and downward, and move the cap 18, in the horizontal and vertical directions.

The engine controller 215 causes the CIS unit 49 to shoot the surface of the conveying belt 46. The engine controller 215 calculates a belt status value at a predetermined first time interval (e.g., 1 minute), on the basis of the image shot by the CIS unit 49, and stores the calculated belt status value in the storage device 400. In this embodiment, the main controller 115, the engine controller 215, and the log controller 315 exemplify the controller according to the disclosure. The CIS unit 49 exemplifies the image pickup device according to the disclosure. Here, although the image forming apparatus 1 includes the main circuit board 100, the engine circuit board 200, and the log circuit board 300 in this embodiment, the image forming apparatus 1 may instead include a single circuit board, and a controller provided on the single circuit board may act as the main controller 115, the engine controller 215, and the log controller 315. In this case, the RAM and the ROM provided on the single circuit board each assume the functions of the RAM and the ROM provided on the other circuit boards.

The storage device 400 includes a memory incorporated in the image forming apparatus 1, and the external memory 5. When storing the belt status value in the external memory 5 via the log controller 315, the engine controller 215 stores the belt status value at a predetermined second time interval (e.g., 10 minutes). This embodiment represents the case where the external memory 5 corresponds to the storage device 400.

The engine controller 215 decides, at a predetermined timing (other than during the execution of printing operation, for example when the power to the image forming apparatus 1 has been turned on, or when the maintenance work for the image forming apparatus 1, such as head cleaning of the line heads 23 is about to be executed), whether the belt status values, representing equal to or more than a predetermined number of times of detection (e.g., 600 times, considered to be sufficient for securing the accuracy of the data) have been stored in the external memory 5. The predetermined number of times is determined in advance, through experiments or simulations. Upon deciding that the belt status values representing equal to or more than the predetermined number of times of detection have been stored in the external memory 5, the engine controller 215 calculates the average of the belt status values accumulated equal to or more than the predetermined number of times. When the engine controller 215 decides that a change of the conveying belt satisfies a predetermined maintenance condition, on the basis of the belt status average value, the main controller 115 causes the display device 10 to display a message urging the user to perform the maintenance work for the conveying belt.

The maintenance condition is that, in the belt status average values from a predetermined number of latest calculations (e.g., three times, the latest calculation inclusive), the absolute value of the difference between one belt status average value and the immediately preceding belt status average value (e.g., the absolute value of the difference between the belt status average value calculated first and the belt status average value calculated second) is equal to or larger than a predetermined value.

The belt status value refers to an amount of deviation of the conveying belt 46 mounted in the image forming apparatus 1, from the reference position (hereinafter, “deviation amount of conveying belt 46”), or the revolution speed of the conveying belt 46.

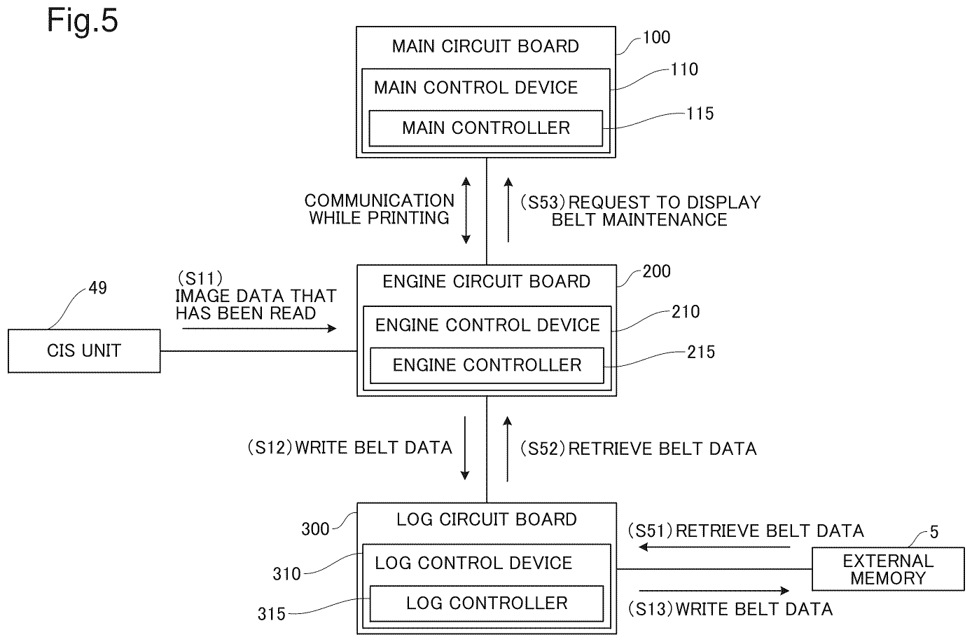

Referring now to FIG. 5, a data collection process and a data analysis process, performed in the image forming apparatus 1 configured as shown in FIG. 2, will be described hereunder. FIG. 5 is a schematic diagram showing flow of data in the data collection process and the data analysis process, performed in the image forming apparatus shown in FIG. 2.

First, the flow of the data in the data collection process, performed in the image forming apparatus shown in FIG. 2, will be described.

The engine controller 215 causes the CIS unit 49 to shoot the surface of the conveying belt 46, while the conveying belt 46 is revolving for the printing operation, and to output the image data of the shot image, to the engine controller 215. To be more specific, the first CIS 49A outputs the image data of the image covering the region from the end portion 46A to the central portion of the conveying belt 46, along the orthogonal direction, to the engine controller 215, and the second CIS 49B outputs the image data of the image covering the region from the other end portion 46B to the central portion of the conveying belt 46, along the orthogonal direction, to the engine controller 215. The engine controller 215 acquires, at the predetermined first time interval, the image data of the respective images shot by the first CIS 49A and the second CIS 49B each time. The engine controller 215 combines the image data of the respective images, thereby generating the overall image data, representing the image of the entirety of the conveying belt 46 along the orthogonal direction, from the end portion 46A to the other end portion 46B.

The engine controller 215 calculates the deviation amount of the conveying belt 46 and the revolution speed thereof, at the predetermined first time interval, on the basis of the image represented by the image data inputted from the first CIS 49A, the image represented by the image data inputted from the second CIS 49B, and the entire image represented by the overall image data, and outputs the belt data regarding the conveying belt 46, indicating the deviation amount and the revolution speed of the conveying belt 46 calculated as above, and also indicating a calculation number for identifying at which point the deviation amount and the revolution speed have been calculated, to the RAM 213 (see FIG. 2) (step S11). Here, since the RAM 213 is a storage region for temporarily saving the data, the memory capacity is relatively small, and therefore the RAM 213 is not suitable for storing the belt data over an extended period of time, having a large amount of data.

At step S11, the engine controller 215 analyzes an image A of the conveying belt 46 represented by the image data inputted from the first CIS 49A, thereby detecting the position of the end portion 46A of the conveying belt 46 along the orthogonal direction orthogonal to the revolving direction of the conveying belt 46, and then calculates the distance between the reference position and the end portion 46A of the conveying belt 46 along the orthogonal direction, on the basis of the detection result.

For example, image data of an image, shot by the first CIS 49A when the end portion 46A of the conveying belt 46 was at the reference position, at an initial stage of use of the image forming apparatus 1, is stored in the ROM 212, as a reference image. The engine controller 215 compares between the reference image and the image A, for example by a known pattern matching method, and calculates the distance between the reference position of the conveying belt 46 and the position of the end portion 46A in the image A in the longitudinal direction, as the deviation amount of the end portion 46A in the image A, with respect to the position of the end portion 46A in the reference image.

In this embodiment, when the end portion 46A of the conveying belt 46 is located on a predetermined side along the orthogonal direction, with respect to the reference position of the conveying belt 46 (e.g., on the side indicated by the arrow in FIG. 4B indicating the orthogonal direction), the engine controller 215 calculates the distance as a positive value. On the contrary, when the end portion 46A of the conveying belt 46 is located on the opposite side of the predetermined side along the orthogonal direction, with respect to the reference position of the conveying belt 46 (e.g., opposite to the side indicated by the arrow in FIG. 4A indicating the orthogonal direction), the engine controller 215 calculates the distance as a negative value.

The engine controller 215 analyzes the entire image, thereby detecting the position of the other end portion 46B of the conveying belt 46 along the orthogonal direction orthogonal to the revolving direction of the conveying belt 46, and then calculates the distance between the reference position and the other end portion 46B of the conveying belt 46 along the orthogonal direction, on the basis of the detection result.

For example, the image data of the entire image, generated by combining the images respectively shot by the first CIS 49A and the second CIS 49B, when the end portion 46A of the conveying belt 46 was at the reference position at an initial stage of use of the image forming apparatus 1, is stored in the ROM 212, as an overall reference image. The engine controller 215 compares between the overall reference image, and entire image generated by combining the images respectively shot by the first CIS 49A and the second CIS 49B, for example by a known pattern matching method, and calculates the distance between the reference position of the conveying belt 46 and the position of the other end portion 46B in the entire image in the longitudinal direction, as the deviation amount of the other end portion 46B in the entire image, with respect to the position of the other end portion 46B in the reference image.

In this embodiment, when the other end portion 46B of the conveying belt 46 is located on the predetermined side along the orthogonal direction, with respect to the reference position of the conveying belt 46 (e.g., on the side indicated by the arrow in FIG. 4B indicating the orthogonal direction), the engine controller 215 calculates the distance as a positive value. On the contrary, when the other end portion 46B of the conveying belt 46 is located on the opposite side of the predetermined side along the orthogonal direction, with respect to the reference position of the conveying belt 46 (e.g., on opposite to the side indicated by the arrow in FIG. 4A indicating the orthogonal direction), the engine controller 215 calculates the distance as a negative value.

The engine controller 215 calculates the deviation amount of the mounting position of the conveying belt 46 from the reference position thereof, on the basis of the calculated distance between the reference position of the conveying belt 46 and the end portion 46A thereof, and the calculated distance between the reference position of the conveying belt 46 and the other end portion 46B thereof. For example, when the distance between the reference position of the conveying belt 46, and the center of the conveying belt 46 having the reference width and mounted at the reference position, is denoted as A, the calculated distance between the reference position of the conveying belt 46 and the end portion 46A thereof is denoted as B, and the calculated distance between the reference position of the conveying belt 46 and the other end portion 46B thereof is denoted as C, the engine controller 215 calculates the deviation amount of the conveying belt 46, through a formula of {(C−B)/2+B}−A.

As described above, the CIS unit 49 outputs the image data representing the image of the surface of the conveying belt 46, to the engine controller 215, while the conveying belt 46 is revolving for the printing operation, and the engine controller 215 further analyzes the image of the conveying belt 46 represented by the image data inputted from the second CIS 49B, and detects the home position hole 52 formed in the conveying belt 46. For example, the image showing the home position hole 52 is stored in advance in the ROM 212, and the engine controller 215 extracts the image showing the home position hole 52, out of the images represented by the image data sequentially outputted from the second CIS 49B, by the pattern matching method. The engine controller 215 measures a time, for example with a built-in timer, between a time that the image showing the home position hole 52 was detected and a time that the next image showing the home position hole 52 has been detected (home position interval time), each time such image is detected. The engine controller 215 stores the belt data indicating the home position interval time measured as above, in the RAM 213. In this embodiment, the speed calculated on the basis of the home position interval time is adopted as the revolution speed of the conveying belt 46.

In this embodiment, eleven pieces of home position holes 52 are formed in the conveying belt 46, the interval between the home position holes 52 is 301 mm, and the length of the conveying belt 46 corresponding to one revolution, in other words the entire length of the conveying belt 46 is 3311 mm. The engine controller 215 controls the drive roller 43 to rotate at a predetermined rotation speed, to cause the conveying belt 46 to run at 762.02 mm per second. In this case, the time after the engine controller 215 has detected one home position hole 52, and until the engine controller 215 detects the immediately next home position hole 52, is 0.395 seconds.

The engine controller 215 retrieves the belt data of the conveying belt 46 stored in the RAM 213 (belt data untransmitted yet) at a predetermined second time interval, and the retrieved belt data of the conveying belt 46, to the log controller 315 (step S12). The engine controller 215 deletes the belt data from the RAM 213, for example upon transmitting that data to the log controller 315. The log controller 315 transmits the belt data of the conveying belt 46 received from the engine controller 215, to the external memory 5, thereby storing therein the belt data of the conveying belt 46 (step S13).

Hereunder, the flow of the data in the data analysis process, performed in the image forming apparatus 1 configured as shown in FIG. 2, will be described.

The engine controller 215 requests the log controller 315 to retrieve the belt data of the conveying belt 46, at a predetermined timing (other than during the execution of printing operation, for example when the power to the image forming apparatus 1 has been turned on, or when the maintenance work for the image forming apparatus 1, such as head cleaning of the line heads 23 is about to be executed). Upon receipt of the request, the log controller 315 retrieves the belt data of the conveying belt 46, from the external memory 5 (step S51). The log controller 315 transmits the belt data of the conveying belt 46 retrieved from the external memory 5, to the engine controller 215, and the engine controller 215 receives the belt data of the conveying belt 46, from the log controller 315 (step S52).

The engine controller 215 decides whether the belt data received from the log controller 315 includes the belt data newly stored in the external memory 5 (belt data unused yet for the calculation of the average value of the deviation amount and the average value of the revolution speed), representing equal to or more than the predetermined number of times of detection. For example, each time the engine controller 215 calculates the average value of the deviation amount and the average value of the revolution speed, the engine controller 215 stores the largest value of the calculation number indicated by the corresponding belt data, in the storage device 400. Upon receipt of the belt data from the log controller 315, the engine controller 215 subtracts the largest value of the calculation number stored in the storage device 400, from the largest value of the calculation number indicated by the belt data received, and decides that the belt data newly stored in the external memory 5 represents equal to or more than the predetermined number of times of detection, when the remainder of the subtraction is equal to or larger than the predetermined number of times. Upon deciding that the belt data newly stored in the external memory 5 represents equal to or more than the predetermined number of times of detection, the engine controller 215 calculates the average value of the deviation amount of the conveying belt 46, and the average value of the revolution speed of the conveying belt 46, on the basis of each piece of the belt data representing equal to or more than the predetermined number of times of detection (belt data newly stored in the external memory 5, and representing equal to or more than the predetermined number of times of detection), and stores the average value of the deviation amount and the average value of the revolution speed that have been calculated in the storage device 400, in association with the average value calculation number, for identifying at which point the average value of the deviation amount and the average value of the revolution speed have been calculated, along with the largest value of the calculation number, indicated by the belt data used for calculating the average value of the deviation amount and the average value of the revolution speed.

The engine controller 215 decides whether a change of the conveying belt 46 satisfies a predetermined maintenance condition, on the basis of the average value of the deviation amount and the average value of the revolution speed. The maintenance condition includes that, as described earlier, in the belt status average values from a predetermined number of latest calculations, the absolute value of the difference between one belt status average value and the immediately preceding belt status average value (e.g., the absolute value of the difference between the belt status average value calculated first and the belt status average value calculated second) is equal to or larger than a predetermined value. In this embodiment, that such absolute value is equal to or larger than the predetermined value includes at least one of the state where, in the average values of the deviation amount from the predetermined number of latest calculations (e.g., three times, the latest calculation inclusive), the absolute value of the difference between one average value of the deviation amount and the immediately preceding average value of the deviation amount is equal to or larger than a predetermined first value (e.g., 0.1 mm, the absolute value of the difference between the average value of the deviation amount calculated first, and the average value of the deviation amount calculated second), or the state where, in the average values of the revolution speed from the predetermined number of latest calculations, the absolute value of the difference between one average value of the revolution speed and the immediately preceding average value of the revolution speed is equal to or larger than a predetermined second value (e.g., 0.1 mm per second, the absolute value of the difference between the average value of the revolution speed calculated first, and the average value of the revolution speed calculated second).

Accordingly, upon deciding at least that, in the average values of the deviation amount from the predetermined number of latest calculations, the absolute value of the difference between one average value of the deviation amount and the immediately preceding average value of the deviation amount is equal to or larger than the predetermined first value, or that, in the average values of the revolution speed from the predetermined number of latest calculations, the absolute value of the difference between one average value of the revolution speed and the immediately preceding average value of the revolution speed is equal to or larger than the predetermined second value, the engine controller 215 decides that the change of the conveying belt 46 satisfies the maintenance condition, but otherwise decides that the change of the conveying belt 46 does not satisfy the maintenance condition. To make the mentioned decision, for example, the engine controller 215 retrieves the average values of the deviation amount and the average values of the revolution speed, from the predetermined number of latest calculations, on the basis of the average value calculation number stored in the storage device 400, and calculates the absolute value of the difference between one average value of the deviation amount and the immediately preceding average value of the deviation amount, and also the absolute value of the difference between one average value of the revolution speed and the immediately preceding average value of the revolution speed.

Upon deciding that the maintenance condition is satisfied, the engine controller 215 requests the main controller 115 to display necessity of belt maintenance (step S53). Upon receipt of the request to display the belt maintenance necessity from the engine controller 215, the main controller 115 causes the display device 10 to display a message urging the user to perform the maintenance work for the conveying belt 46 (e.g., a sentence as “Conveying belt needs maintenance work”).

Referring now to FIG. 6, the data collection process performed by the image forming apparatus 1 will be described hereunder. FIG. 6 is a flowchart for explaining the data collection process performed by the image forming apparatus 1 shown in FIG. 2.

The engine controller 215 receives a printing request (step S101), and starts to perform the printing operation (step S102).

The engine controller 215 causes the CIS unit 49 to shoot the image of the conveying belt 46, while the conveying belt 46 is revolving for the printing operation, and to output the image data representing the shot image, to the engine controller 215. The engine controller 215 calculates the deviation amount and the revolution speed of the conveying belt 46 as described earlier, at the first time interval, on the basis of the image of the conveying belt 46, represented by the image data inputted from the CIS unit 49, and stores the belt data of the conveying belt 46, indicating the calculated values of the deviation amount and the revolution speed of the conveying belt 46, in the RAM 213 (step S103).

Then the engine controller 215 decides whether the time for storing the belt data in the external memory 5 has been reached (step S104). The belt data is written in the external memory 5, at the second time interval. Upon deciding at step S104 that the time for storing the belt data in the external memory 5 has not been reached (NO at S104), the engine controller 215 returns to step S103.

Upon deciding at step S104 that the time for storing the belt data in the external memory 5 has been reached (YES at S104), the engine controller 215 retrieves the belt data of the conveying belt 46 stored in the RAM 213 (belt data untransmitted yet), and transmits the retrieved belt data of the conveying belt 46 to the log controller 315. The log controller 315 transmits the received belt data to the external memory 5, thereby storing the belt data in the external memory 5 (step S105).

The engine controller 215 finishes the printing operation (step S106), thus finishing the data collection process specified in FIG. 6.

The operation from step S103 to step S105 is repeatedly performed, during the period from the start of the printing operation to the finish thereof.

Referring to FIG. 7, the data analysis process performed by the image forming apparatus 1 will be described hereunder. FIG. 7 is a flowchart for explaining the data analysis process, performed by the image forming apparatus 1 shown in FIG. 2.

The engine controller 215 requests the log controller 315 to retrieve the belt data of the conveying belt 46, at a predetermined timing (other than during the execution of printing operation, for example when the power to the image forming apparatus 1 has been turned on, or when the maintenance work for the image forming apparatus 1, such as head cleaning of the line heads 23 is executed). Upon receipt of such request, the log controller 315 retrieves the belt data of the conveying belt 46, from the external memory 5, and transmits the retrieved belt data of the conveying belt 46 to the engine controller 215. The engine controller 215 receives the belt data of the conveying belt 46 (step S151).

The engine controller 215 decides whether the belt data retrieved from the external memory 5 includes the belt data newly stored in the external memory 5 (belt data unused yet for the calculation of the average value of the deviation amount and the average value of the revolution speed), representing equal to or more than the predetermined number of times of detection (step S152). When the engine controller 215 decides at step S152 that no such belt data is included (NO at S152), the data analysis process specified in FIG. 7 is finished.

Upon deciding at step S152 that the mentioned belt data is included (YES at S152), the engine controller 215 calculates the average value of the deviation amount of the conveying belt 46, and the average value of the revolution speed of the conveying belt 46, on the basis of each piece of the belt data representing equal to or more than the predetermined number of times of detection (belt data newly stored in the external memory 5, and representing equal to or more than the predetermined number of times of detection), and stores the calculated average value of the deviation amount and the calculated average value of the revolution speed, in the storage device 400 (step S153).

The engine controller 215 compares the average values of the deviation amount from the predetermined number of latest calculations (the latest one inclusive), and also the average values of the revolution speed from the predetermined number of latest calculations (the latest one inclusive) (step S154).

The engine controller 215 decides whether the maintenance condition is satisfied, on the basis of the comparison result acquired at step S154 (step S155). Upon deciding at least that, in the average values of the deviation amount from the predetermined number of latest calculations, the absolute value of the difference between one average value of the deviation amount and the immediately preceding average value of the deviation amount is equal to or larger than the first value, or that, in the average values of the revolution speed from the predetermined number of latest calculations, the absolute value of the difference between one average value of the revolution speed and the immediately preceding average value of the revolution speed is equal to or larger than the second value, the engine controller 215 decides that the change of the conveying belt 46 satisfies the maintenance condition, but otherwise decides that the change of the conveying belt 46 does not satisfy the maintenance condition. When the engine controller 215 decides at step S155 that the maintenance condition is not satisfied (NO at S155), the data analysis process specified in FIG. 7 is finished.

Upon deciding at step S155 that the maintenance condition is satisfied (YES at S155), the engine controller 215 requests the main controller 115 to display necessity of belt maintenance. Upon receipt of the request to display the belt maintenance necessity from the engine controller 215, the main controller 115 causes the display device 10 to display a message urging the user to perform the maintenance work for the conveying belt 46 (step S156). Thereafter, the data analysis process specified in FIG. 7 is finished.

According to the foregoing embodiment, the engine controller 215 calculates the deviation amount and the revolution speed of the conveying belt 46 at the first time interval, on the basis of the image of the conveying belt 46 acquired from the CIS unit 49, and stores the belt data indicating the deviation amount and the revolution speed of the conveying belt 46 that have been calculated, at the second time interval in the external memory 5 via the log controller 315. Therefore, the change of the status of the conveying belt 46 can be recognized before an error occurs, on the basis of the deviation amount and the revolution speed of the conveying belt 46 indicated by the belt data provided at the first time interval.

The engine controller 215 stores the belt data, indicating the deviation amount and the revolution speed of the conveying belt 46 that have been calculated, in the RAM 213, and stores the belt data in the RAM 213 in the external memory 5 via the log controller 315, at the second time interval. Therefore, the usage of the capacity of the RAM 213, arising from storing the belt data therein, can be prevented from excessively increasing.

In addition, when the belt data newly stored in the external memory 5 represents equal to or more than the predetermined number of times of detection, the engine controller 215 calculates the average value of the deviation amount of the conveying belt 46, and the average value of the revolution speed of the conveying belt 46, on the basis of each piece of the belt data representing equal to or more than the predetermined number of times of detection. Upon deciding at least that, in the average values of the deviation amount from the predetermined number of latest calculations, the absolute value of the difference between one average value of the deviation amount and the immediately preceding average value of the deviation amount is equal to or larger than the first value, or that, in the average values of the revolution speed from the predetermined number of latest calculations, the absolute value of the difference between one average value of the revolution speed and the immediately preceding average value of the revolution speed is equal to or larger than the second value, the engine controller 215 decides that the change of the conveying belt 46 satisfies the maintenance condition. Upon deciding that the maintenance condition is satisfied, the engine controller 215 requests the main controller 115 to display the necessity of belt maintenance. Upon receipt of the request to display the belt maintenance necessity, the main controller 115 causes the display device 10 to display a message urging the user to perform the maintenance work for the conveying belt 46. Therefore, the user can be exempted from the burden of taking the trouble to visually check the status of the conveying belt 46, and facilitated to perform the maintenance work for the conveying belt 46, before the image forming apparatus 1 suspends the operation owing to abnormality of the conveying belt 46.

According to the foregoing embodiment, for example, the maintenance condition is satisfied when, in the belt status average values from the predetermined number of latest calculations, the absolute value of the difference between one belt status average value and the immediately preceding belt status average value is equal to or larger than the predetermined value (more specifically, at least when, in the average values of the deviation amount from the predetermined number of latest calculations, the absolute value of the difference between one average value of the deviation amount and the immediately preceding average value of the deviation amount is equal to or larger than the predetermined first value, or when, in the average values of the revolution speed from the predetermined number of latest calculations, the absolute value of the difference between one average value of the revolution speed and the immediately preceding average value of the revolution speed is equal to or larger than the predetermined second value). However, the maintenance condition is not limited to the above, but may be specified, for example, as the following variations.

The maintenance condition may be specified such that, in the belt status average values from the predetermined number of latest calculations, the absolute value of the difference between one belt status average value and the immediately preceding belt status average value is larger than the absolute value of a value corresponding to a predetermined ratio (e.g., 30%) of the immediately preceding belt status average value (more specifically, at least that, in the average values of the deviation amount from the predetermined number of latest calculations (e.g., three times, the latest one inclusive), the absolute value of the difference between one average value of the deviation amount and the immediately preceding average value of the deviation amount is equal to or larger than the absolute value of a value corresponding to a predetermined first ratio (e.g., 30%) of the immediately preceding average value of the deviation amount, or that, in the average values of the revolution speed amount from the predetermined number of latest calculations, the absolute value of the difference between one average value of the revolution speed and the immediately preceding average value of the revolution speed is equal to or larger than the absolute value of a value corresponding to a predetermined second ratio (e.g., 30%) of the immediately preceding average value of the revolution speed). For example, when the first ratio is set to 30%, and the (N−2)th average value of the deviation amount is 0.3 mm, the (N−1)th average value of the deviation amount is 0.6 mm, and the Nth average value of the deviation amount is 0.9 mm, the absolute value 0.3 mm of the difference between the (N−1)th average value of the deviation amount of 0.6 mm, and (N−2)th average value of the deviation amount of 0.3 mm, which is the immediately preceding value, is larger than an absolute value 0.09 mm, corresponding to the first ratio 30% of the (N−2)th average value of the deviation amount of 0.3 mm, which is the immediately preceding value. Likewise, the absolute value 0.3 mm of the difference between the Nth average value of the deviation amount of 0.9 mm, and (N−1)th average value of the deviation amount of 0.6 mm, which is the immediately preceding value, is larger than an absolute value 0.18 mm, corresponding to the first ratio 30% of the (N−1)th average value of the deviation amount of 0.6 mm, which is the immediately preceding value. Therefore, the engine controller 215 decides that the maintenance condition is satisfied.

Alternatively, the maintenance condition may be specified such that the belt status average value is out of a predetermined range (e.g., from 5 to 10, both ends inclusive), for example at least that the average value of the deviation amount is out of a predetermined first range (e.g., between- 1 mm and 1 mm, both ends inclusive), or that the absolute value of the average value of the revolution speed is out of a predetermined second range (e.g., from 762.02−1 mm/second to 762.02+1 mm/second, both ends inclusive, with respect to the reference speed of 762.02 mm/second). For example, in the case where the image forming apparatus 1 is set to suspend the operation owing to error, when the absolute value of the deviation amount of the conveying belt 46 reaches 2 mm, and the first range is set to −1 mm to 1 mm, both ends inclusive, the engine controller 215 decides that the maintenance condition is satisfied, when the average value of the deviation amount is out of the range of −1 mm to 1 mm, both ends inclusive, and decides that the maintenance condition is not satisfied, when the average value of the deviation amount falls in the range of −1 mm to 1 mm, both ends inclusive.

The maintenance conditions according to the foregoing embodiment and the variations thereof may be specified only with respect to the average value of the deviation amount of the conveying belt 46, or only with respect to the average value of the revolution speed of the conveying belt 46.

Although the engine controller 215 calculates the average value of the deviation amount of the conveying belt 46 and the revolution speed thereof, on the basis of the image of the conveying belt 46 shot by the CIS unit 49, according to the embodiment, the disclosure is not limited to such embodiment. For example, a processor provided in the CIS unit 49 may calculate the average value of the deviation amount of the conveying belt 46 and the revolution speed thereof, on the basis of the shot image of the conveying belt 46. In this case, the processor provided in the CIS unit 49 exemplifies the controller according to the disclosure.

In addition, although the belt status values of the conveying belt 46 are accumulated in the external memory 5, according to the embodiment, the disclosure is not limited to such embodiment. For example, the belt status values may be accumulated in a memory incorporated in the image forming apparatus 1, such as a non-volatile memory.

In the case of the existing image forming apparatuses, the error information is only accumulated after the error occurs, and therefore a change in status of the conveying belt is unable to be recognized in advance, on the basis of the error information.

In contrast, the configuration according to the disclosure enables the change in status of the conveying belt to be recognized, before an error occurs.

The disclosure may be modified in various manners, without limitation to the configuration according to the foregoing embodiment. Further, the configurations and processings described in the embodiments with reference to FIG. 1 to FIG. 7 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming apparatus comprising:
a conveying belt that transports a recording sheet, by performing a revolving movement;
an image pickup device that shoots an image of the conveying belt;
a storage device; and
a control device that includes a processor, and acts as a controller when the processor executes a program,
wherein the controller calculates a belt status value on a basis of the image of the conveying belt shot by the image pickup device, at a predetermined first time interval, and stores the calculated belt status value in the storage device.

2. The image forming apparatus according to claim 1,
wherein the storage device includes at least one of a memory incorporated in the image forming apparatus, or an external memory, and
when storing the belt status value in the external memory, the controller stores the belt data at a predetermined second time interval.

3. The image forming apparatus according to claim 1, further comprising a display device,
wherein the controller is configured to:
decide, at a predetermined timing, whether the belt status values stored in the storage device include the belt status values representing equal to or more than a predetermined number of times of detection, considered to be sufficient for securing accuracy of the data;
calculate, upon deciding that the belt status values stored in the storage device include the belt status values representing equal to or more than the predetermined number of times of detection, a belt status average value which is an average of the belt status values representing equal to or more than the predetermined number of times of detection; and
cause the display device, upon deciding that a change of the conveying belt satisfies a predetermined maintenance condition, on a basis of the belt status average value, to display information urging a user to perform maintenance work for the conveying belt.

4. The image forming apparatus according to claim 3,
wherein the maintenance condition includes that, in the belt status average values from a predetermined number of latest calculations, an absolute value of a difference between one belt status average value, and another belt status average value from the immediately preceding calculation, is equal to or larger than a predetermined value.

5. The image forming apparatus according to claim 3,
wherein the maintenance condition includes that, in the belt status average values from a predetermined number of latest calculations, an absolute value of a difference between one belt status average value, and another belt status average value from the immediately preceding calculation, is equal to or larger than an absolute value of a value corresponding to a predetermined ratio of the other belt status average value from the immediately preceding calculation.

6. The image forming apparatus according to claim 3,
wherein the maintenance condition includes that the belt status average value is out of a predetermined range.

7. The image forming apparatus according to claim 1,
wherein the belt status value includes a deviation amount of a mounting position of the conveying belt, from a reference position at which the conveying belt is to be mounted in the image forming apparatus, or revolution speed of the conveying belt.

8. The image forming apparatus according to claim 1,
wherein the image pickup device includes a contact image sensor (CIS).

9. The image forming apparatus according to claim 2,
wherein the second time interval is longer than the first time interval.
